(19) United States
(12) Patent Application Publication
(10) Pub. No.: US 2002/0086718 A1
(43) Pub. Date: Jul. 4, 2002

(54) Method of and an apparatus for monitoring the condition of batteries used by a mobile radio telecommunications fleet

(76) Inventors: Jonathan Bigwood, Cambridge (GB); Edward Hamilton Dudley Wood, Cambridge (GB)

Correspondence Address: SCHWEGMAN, LUNDBERG, WOESSNER & KLUTH, P.A., P.O. BOX 2938, MINNEAPOLIS, MN, 55402, US

(21) Appl. No.: 09/994,301

(22) Filed: Nov. 26, 2001

Related U.S. Application Data
(63) Continuation of application No. 09/809,345, filed on Mar. 15, 2001.
Application No. 09/809,345 is a continuation of application No. PCT/GB99/03078, filed on Sep. 16, 1999.

(30) Foreign Application Priority Data
Sep. 17, 1998 (GB) GB 9820271.6

(51) Int. Cl. H04B 1/38

(52) U.S. Cl. 455/572; 340/7.32

(57) ABSTRACT

The condition of batteries 4 used to power one or more mobile radio units 3 of a mobile radio telecommunications fleet is automatically monitored. The mobile radio units 3 provide information regarding the condition of the battery 4 powering the respective unit 3, together with an identifier identifying the associated battery, to a data store 7. The data store 7 stores the information. This is done automatically, without the need for user input.

### RELATED APPLICATIONS

This application is a continuation under 37 C.F.R. 1.53(b) of U.S. Ser. No. 09/809,345, filed Mar. 15, 2001, which was a continuation of International Application No. PCT/GB99/03078, filed on Sep. 16, 1999, which claimed priority from Great Britain Application No. 9820271.6, filed on Sep. 17, 1998, which applications are incorporated herein by reference.

### FIELD OF THE INVENTION

The present invention relates to a method of and an apparatus for monitoring the condition of batteries used to power mobile radio units of a mobile radio telecommunications fleet.

### BACKGROUND OF THE INVENTION

Mobile radio units for use in mobile radio telecommunications systems are usually powered by batteries, at least for part of the time. As is known in the art, all batteries have a finite life and degrade over time, such that the operational life of the same battery when fully charged will over time decrease and in particular be less than the nominal operational life of the battery. This can be a problem if a minimum length of mobile radio use is required (for example the length of a police shift), as batteries which can nominally last long enough may in practice not be able to do so.

It is often important therefore to users of mobile radios to be able to identify and discard swiftly substandard or unsuitable batteries. This is particularly the case for operators of larger fleets of mobile radio units, where a pool of batteries is shared by the fleet. In this case batteries may be constantly in use over multiple shifts and used by different individuals, and yet controllers or managers of the mobile radio fleet will wish to be able to readily identify and discard unsuitable batteries from the pool. This problem is compounded because individual batteries in the pool will ‘age’ at different rates, e.g. depending on usage patterns and other factors. This makes it more difficult to predict which batteries need replacing.

One way to try to manage such a pool of batteries would be to rely on individual users to identify and/or discard batteries that they find to be performing poorly. They could be helped in this by being provided with batteries and/or mobile units that can indicate the current condition, e.g. absolute capacity of the battery. However, the applicants have found that in practice individual users will not always reliably discard substandard batteries, such that frequently they will be returned to the pool of batteries and reused a number of times before finally being discarded. This is undesirable.

Another way to monitor the performance of the pool of batteries would be to require the individual users to regularly return their batteries to a central location to have their condition checked by the fleet controller or operator. This would reduce the reliance on individual mobile radio users to identify unsuitable batteries. However, it may not always be desirable to require users to return their batteries to a particular location for such monitoring. For example users may be able to charge and maintain their batteries themselves, independently of the rest of the fleet, and/or it may not always be convenient for them to return their batteries for monitoring regularly.

### SUMMARY OF THE INVENTION

According to a first aspect of the present invention, there is provided a method of monitoring the condition of batteries used to power one or more mobile radio units of a mobile radio telecommunications fleet, comprising:

the or each mobile radio unit providing to a data store information regarding the condition of the battery powering it by transmitting over the air interface information relating to the condition of its battery together with an identifier for identifying the battery to the data store; and

storing at the data store the battery condition information together with its associated battery identifier transmitted by the or each mobile radio unit.

According to a second aspect of the present invention, there is provided a mobile radio telecommunications system, comprising:

a fleet of one or more battery powered mobile radio units, each unit comprising means for determining one or more parameters indicative of the condition of the battery currently powering it, and means for transmitting the determined parameters over the air interface together with an identifier for identifying the associated battery;

means for receiving from each mobile radio unit the transmitted battery parameters and battery identifier; and

means for storing the received battery parameters and their associated battery identifier transmitted by the mobile radio unit or units;

whereby the condition of the batteries powering the fleet of mobile radio units may be monitored.

According to a third aspect of the present invention, there is provided a method of monitoring the condition of batteries used to power a fleet of mobile radio units of a mobile radio telecommunications system, comprising:

forming a database of battery condition information by means of the mobile units, in use, transmitting to the database over the air interface information regarding the condition of their battery together with an identifier for identifying the associated battery to which the battery condition information relates.

In the present invention mobile radio units of the fleet transmit information relating to their battery's present condition to a data store, i.e. information relating to battery condition is transmitted over the air interface of the radio system to a data store or database. This provides an automatically updated database of the current condition of batteries used by the fleet without the need to rely on individual users to check and communicate their batteries' condition or to return their batteries for monitoring.

An identifier identifying the battery in question is associated (and transmitted and stored) with the battery condition information and parameters. This makes it easier to identify and track the battery in the pool to which the given condition information applies. Associating the battery condition data with a battery identity helps a fleet manager to observe and manage the condition of the pool of batteries, particularly where individual batteries will be continually placed in different mobile radio units (such that solely associating the battery condition data with a mobile radio unit's identity may not be sufficient to adequately track the location of a given battery in the pool).

Thus a fleet coordinator or manager can much more readily and conveniently and accurately monitor the batteries' condition and identify and discard any substandard batteries.

The information regarding battery condition to be transmitted and stored can be selected as desired. It can typically comprise one or more parameters indicative of battery condition, such as the current state of charge, number of charge/discharge cycles, etc of the battery. Preferably at least the current battery absolute capacity is determined and transmitted, as this parameter is a good indicator of the life of a battery when fully charged (and thus its ability to last for a particular time period, e.g. user shift).

Most preferably the battery condition data is also associated (and transmitted and stored) with an identifier identifying the particular mobile radio unit, as this, for example, allows the battery to be more readily located and also individual users' usage to be better monitored. For example, when both the battery identity and mobile radio unit identity are used, the fleet manager can identify the battery's current location (by correlating the battery identity and the mobile unit identity) and, for example, send a message to the appropriate user to discard the battery.

As well as being transmitted the condition data can also be displayed in an appropriate manner by the mobile radio unit to give a direct indication to the user of their battery's current state, if desired.

The current condition of the battery should be determined automatically in use, i.e. without requiring user intervention. It could be determined automatically by the mobile radio transceiver unit which it is currently powering, and the mobile radio units could be equipped with suitable detection and determination means for this purpose.

Alternatively the batteries themselves could be arranged to monitor and determine, and include means for monitoring and determining, automatically their own condition, and to then communicate that information to and be interrogated by the mobile radio unit in use. As a further alternative a battery charger could be arranged to determine automatically the battery's condition and communicate it to the battery where it may be stored for future transmission.

The battery condition information can, for example, be determined and then transmitted substantially immediately or it can be stored (e.g. by the battery or mobile radio unit) prior to transmission, as desired.

The battery condition information is preferably provided to the data store periodically and most preferably at regular intervals. For example the, and most preferably each, mobile radio unit could be arranged to provide an update at particular, preferably predetermined, time intervals. Preferably the arrangement is such that at least one update is provided from or for each mobile radio unit and/or battery in the fleet which is in use in a particular, preferably predetermined period, for example such that an update is provided every particular, preferably predetermined number of hours (e.g. every 24 hours). In this way the present invention provides a particularly convenient way of achieving regular updates, but without requiring individual users to return their batteries regularly for monitoring.

Battery condition updates can alternatively or additionally be triggered by particular or predetermined events. These events could be related to the use or conditions of the mobile radio unit. For example an update could be provided each time the mobile unit registers with a new base station. Alternatively or additionally, they could be battery condition related events. For example an update could be provided if the battery's current absolute capacity falls below a predetermined level, or if its current capacity is less than a predetermined level.

The mobile radio units could be arranged themselves to automatically and/or spontaneously transmit the battery condition data to the data store. Alternatively or additionally they could be arranged to do so automatically in response to an external request or interrogation to do so, for example from the fixed radio network, e.g. data store. This latter arrangement can permit a fleet controller to coordinate the information collection more flexibly.

The data transmission (and interrogation of the mobile units, if required) can be performed as desired. Conveniently it can use a standard data service of the mobile radio system in question, such as the Short Data Service of the TETRA (TErrestrial Trunked RAdio) system or the short message service of the GSM system.

The received and stored battery condition data can be used as desired to build up a database of various parameters of the performance of each battery and, optionally, mobile radio unit. This provides a central, convenient and relatively accurate information store which can be interrogated at any time for any appropriate criteria. Thus, for example, the stored data could be used to identify all batteries that offer less than a particular current absolute capacity.

The present invention thus provides a convenient mechanism for monitoring the performance of a pool of batteries used by a fleet of mobile radios that avoids the need to rely on individual users to monitor and provide information on their own batteries, and to have all batteries returned to particular, restricted locations for monitoring.

The invention can be used for any mobile radio system, such as private or public mobile radio systems or cellular telephone systems. The mobile radio units may be mobile radios, mobile phones, handheld or vehicle mounted, etc.

The methods in accordance with the present invention may be implemented at least partially using software e.g. computer programs. It will thus be seen that when viewed from a further aspect the present invention provides computer software specifically adapted to carry out the methods hereinabove described when installed on data processing means. The invention also extends to a computer software carrier comprising such software which when used to operate a radio system comprising a digital computer causes in conjunction with said computer said system to carry out the steps of the method of the present invention. Such a computer software carrier could be a physical storage medium such as a ROM chip, CD ROM or disk, or could be a signal such as an electronic signal over wires, an optical signal or a radio signal such as to a satellite or the like.

It will further be appreciated that not all steps of the method of the invention need be carried out by computer software and thus from a further broad aspect the present invention provides computer software and such software installed on a computer software carrier for carrying out at least one of the steps of the methods set out hereinabove.

### BRIEF DESCRIPTION OF THE DRAWINGS

A preferred embodiment of the present invention will now be described by way of example only and with reference to the accompanying drawings, in which:

FIG. 1 shows schematically a mobile radio unit; and

FIG. 2 shows schematically a mobile radio system.

The present invention is concerned in particular with the monitoring and management of a pool of batteries that power a fleet of mobile radio units in a mobile radio telecommunications system. The fleet could, for example be a fleet of police mobile radio units. As noted above, controllers of such fleets often wish to be able to identify batteries that may be under-performing or have reached the end of their useful life so that they can be removed from the pool of batteries available to the fleet.

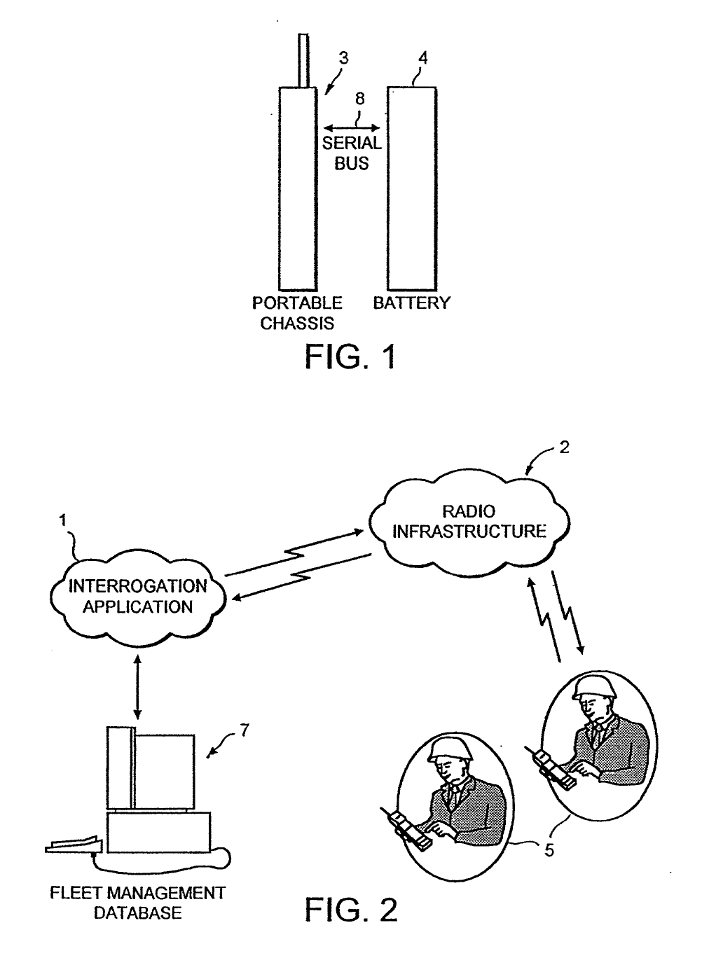

FIG. 1 shows schematically a typical mobile radio unit that might be part of a fleet of plural such units. It comprises a portable radio transceiver unit or chassis 3 which is powered by a battery 4.

### DETAILED DESCRIPTION OF THE PREFERRED EMBODIMENT

In the present embodiment each battery 4 used by the fleet is fitted with a small microprocessor that is arranged to constantly monitor the battery absolute capacity and other battery related parameters, such as the number of charge/discharge cycles, etc. This information is constantly updated for the life of the battery. In use, the microchip on the battery can communicate with the portable transceiver unit 3 via a serial bus 8, and the radio unit 3 can interrogate the microprocessor to obtain this battery condition information. In an alternative arrangement, the radio transceiver unit could be arranged to provide this battery monitoring function.

FIG. 2 illustrates a radio telecommunications system. It comprises a radio infrastructure 2 via which plural mobile radio units 5 of a fleet can communicate with each other and other parties. As is often the case the mobile radio fleet is controlled and monitored by a fleet controller or manager who can access and use a fleet management database 7 which can record information relating to the mobile radio fleet for this purpose. The database 7 can be in a single location or distributed, as desired. The mobile units of the fleet can be interrogated in use by an interrogation application 1 to obtain information about their current status, condition, etc. Communication between the interrogation application 1 and the radio infrastructure 2 can be, for example, via an air interface or wire connection, as desired.

An example of operation of the radio system in accordance with the present invention will now be described. The interrogation application 1 is arranged at intervals to initiate a poll interrogation sequence to mobile radio units known to be in the field to enquire of the current condition of their batteries. Interrogation application 1 can, for example, be arranged to automatically interrogate each portable and battery in the mobile radio fleet, within a selected period, such as once in 24 hours per mobile radio unit and battery. The radio network 2 passes the interrogation messages via the air interface to the remote radio units 5, using, for example, standard data messages (such as the Short Data Service feature of the TETRA system).

When a remote mobile radio unit 5 receives the poll message, it interrogates the microprocessor in its current battery as to the current condition of the battery. The battery 4 responds to the radio unit with its health information, and the radio transceiver 3 then transmits parameters relating to the battery condition back to the fixed radio network over the air (radio) interface using the standard messaging system of the radio system. The battery condition parameters are transmitted together with the identity of the battery and mobile radio unit in question (every mobile radio unit has a different over-air number, and each battery has a unique identification number).

The battery condition information can also be used to provide an on screen display of, e.g. the current battery capacity and/or strength to give a visual indication of the remaining battery life to the user, if desired.

The interrogation application 1 receives the response from the mobile radio units via the fixed radio network and stores them in the fleet management database 7 to build up a record of received battery condition information against radio identity and battery identity.

In this way a database of various parameters of the performance of the radio units and batteries in the fleet can be built up.

The database can be interrogated at will by the fleet manager or generate reports automatically, at any time for any criteria. Thus an interrogation could be made for all batteries that offer less than 70% of their original, nominal absolute capacity. The database would report the unique identities of all such batteries and associated radio units that met this criteria, thereby allowing remedial action such as removing out of specification batteries from service for repair or replacement to be initiated.

It can be seen that in the present embodiment each mobile radio unit can be interrogated over the air interface to automatically report various battery condition parameters, such as the absolute battery capacity. This facilitates battery management, and without any reliance on individual user intervention.

1. A method of monitoring the condition of batteries used to power one or more mobile radio units of a mobile radio telecommunications fleet, comprising:
the or each mobile radio unit providing to a data store information regarding the condition of the battery powering it by transmitting over the air interface information relating to the condition of its battery together with an identifier for identifying the battery to the data store; and
storing at the data store the battery condition information together with its associated battery identifier transmitted by the or each mobile radio unit.

2. A method of monitoring the condition of batteries used to power a fleet of mobile radio units of a mobile radio telecommunications system, comprising:
forming a database of battery condition information by means of the mobile units, in use, transmitting to the database over the air interface information regarding the condition of their batteries together with an identifier for identifying the associated battery to which the battery condition information relates.

3. The method of claim 1 or claim 2, wherein the battery condition information includes the current battery absolute capacity.

4. The method of any one of claims 1 to 3, wherein the battery condition information is transmitted and stored with an identifier identifying the particular mobile radio unit.

5. The method of any one of claims 1 to 4, wherein the battery condition information is displayed by the mobile radio unit.

6. The method of any one of claims 1 to 5, wherein the battery condition information is determined by the mobile radio unit.

7. The method of any one of claims 1 to 6, wherein a battery charger determines the battery's condition and communicates it to the battery or mobile radio unit.

8. The method of any one of claims 1 to 7, wherein the battery condition information is provided to the data store or database periodically, at regular intervals.

9. The method of any one of claims 1 to 8, wherein the mobile radio units automatically transmit the battery condition information to the data store or database.

10. The method of any one of claims 1 to 9, wherein the mobile radio units transmit the battery condition information in response to a request from the data store or database.

11. The method of any one of claims 1 to 10, wherein the transmission of the battery condition information uses the Short Data Service of a TETRA (TErrestrial Trunked RAdio) system.

12. A mobile radio telecommunications system, comprising:
a fleet of one or more battery powered mobile radio units, each unit comprising means for determining one or more parameters indicative of the condition of the battery currently powering it, and means for transmitting the determined parameters over the air interface together with an identifier for identifying the associated battery;
means for receiving from each mobile radio unit the transmitted battery parameters and battery identifier; and
means for storing the received battery parameters and their associated battery identifier transmitted by the mobile radio unit or units;
whereby the condition of the batteries powering the fleet of mobile radio units may be monitored.

13. The system of claim 12, wherein the battery of the or each radio unit has means for monitoring and determining its own condition and, in use, communicating that information to its mobile radio unit.

14. The system of claim 12 or claim 13, wherein the battery condition information includes the current battery absolute capacity.

15. The system of any one of claims 12 to 14, wherein the battery condition information is transmitted and stored with an identifier identifying the particular mobile radio unit.

16. Computer software and such software installed on a computer software carrier for carrying out at least one of the steps of the method of any one of claims 1 to 11.

17. A method of monitoring the condition of batteries used to power one or more mobile radio units of a mobile radio telecommunications fleet substantially as hereinbefore described with reference to any one of the accompanying drawings.

18. A mobile radio telecommunications system substantially as hereinbefore described with reference to any one of the accompanying drawings.

19. A method of monitoring the condition of batteries used to power one or more mobile radio units of a mobile radio telecommunications fleet, comprising:
the or each mobile radio unit providing to a data store information regarding the condition of the battery powering it by transmitting over the air interface information relating to the condition of its battery together with an identifier for identifying the battery to the data store; and
storing at the data store the battery condition information together with its associated battery identifier transmitted by the or each mobile radio unit.

20. A method of monitoring the condition of batteries used to power a fleet of mobile radio units of a mobile radio telecommunications system, comprising: forming a database of battery condition information by means of the mobile units, in use, transmitting to the database over the air interface information regarding the condition of their batteries together with an identifier for identifying the associated battery to which the battery condition information relates.

21. The method of claim 19, wherein the battery condition information includes the current battery absolute capacity.

22. The method of claim 19, wherein the battery condition information is transmitted and stored with an identifier identifying the particular mobile radio unit.

23. The method of claim 19, wherein the battery condition information is displayed by the mobile radio unit.

24. The method of claim 19, wherein the battery condition information is determined by the mobile radio unit.

25. The method of claim 19, wherein a battery charger determines the battery's condition and communicates it to the battery or mobile radio unit.

26. The method of claim 19, wherein the battery condition information is provided to the data store periodically, at regular intervals.

27. The method of claim 19, wherein the mobile radio units automatically transmit the battery condition information to the data store.

28. The method of claim 19, wherein the mobile radio units transmit the battery condition information in response to a request from the data store.

29. The method of claim 19, wherein the transmission of the battery condition information uses the Short Data Service of a TETRA (TErrestrial Trunked RAdio) system.

30. A mobile radio telecommunications system, comprising:
a fleet of one or more battery powered mobile radio units, each unit comprising means for determining one or more parameters indicative of the condition of the battery currently powering it, and means for transmitting the determined parameters over the air interface together with an identifier for identifying the associated battery;
means for receiving from each mobile radio unit the transmitted battery parameters and battery identifier; and
means for storing the received battery parameters and their associated battery identifier transmitted by the mobile radio unit or units;
whereby the condition of the batteries powering the fleet of mobile radio units may be monitored.

31. The system of claim 30, wherein the battery of the or each radio unit has means for monitoring and determining its own condition and, in use, communicating that information to its mobile radio unit.

32. The system of claim 30, wherein the battery condition information includes the current battery absolute capacity.

33. The system of claim 30, wherein the battery condition information is transmitted and stored with an identifier identifying the particular mobile radio unit.

34. Computer software and such software installed on a computer software carrier for carrying out the method of claim 19.

35. Computer software and such software installed on a computer software carrier for carrying out the method of claim 20.
